(19) United States
(12) Patent Application Publication
(10) Pub. No.: US 2013/0066667 A1
(43) Pub. Date: Mar. 14, 2013

(54) Wireless Vehicle Valet Management System

(71) Applicants: Gokhan Gulec, Plantation, FL (US); Selim Esen, Plantation, FL (US)

(72) Inventors: Gokhan Gulec, Plantation, FL (US); Selim Esen, Plantation, FL (US)

(21) Appl. No.: 13/671,554

(22) Filed: Nov. 7, 2012

Related U.S. Application Data
(63) Continuation-in-part of application No. 12/848,627, filed on Aug. 2, 2010.
Application No. 12/848,627 is a continuation-in-part of application No. 12/650,732, filed on Dec. 31, 2009, now abandoned.
Application No. 12/650,732 is a continuation-in-part of application No. 11/970,956, filed on Jan. 8, 2008, now abandoned.
(60) Provisional application No. 60/879,183, filed on Jan. 8, 2007.

(51) Int. Cl. G06Q 10/06

(52) U.S. Cl. 705/7.13

(57) ABSTRACT

A wireless vehicle valet management system comprising multipart barcoded valet tickets, a plurality of wireless handheld communication devices for entering customer, vehicle and valet information and communicating it to the system, a server, software, at least one database and a communication network. The wireless handheld communication devices (also referred to herein as “handheld unit or units”) preferably comprise a cellular telephone having applications programming capability and allow simultaneous communication with a plurality of handheld units from a central dispatch location. A system and method for retrieval of a parked vehicle includes offering the retrieval assignment to the attendants who are the closest to the vehicle to be retrieved.

### CROSS REFERENCE TO RELATED APPLICATIONS

This application is a continuation-in-part of U.S. patent application Ser. No. 12/848,627, filed Aug. 2, 2010, which is a continuation-in-part of patent application Ser. No. 12/650,732 filed Dec. 31, 2009, which in turn is a continuation-in-part of patent application Ser. No. 11/970,956 filed Jan. 8, 2008, which claims the benefit of provisional patent application Ser. No 60/879,183 filed Jan. 8, 2007, which are herein incorporated by reference in their entireties.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

This invention relates generally to a vehicle valet management system, and more particularly, to a wireless vehicle valet inventory tracking and management system that communicates with valet attendants in real time to improve efficiency and identifies, stores and provides vehicle identification information of vehicles being parked, current parking location information, vehicle retrieval requests, attendant identity data and management related information, including repeat customer information and employee performance information.

Computer-based automobile or vehicle valet monitoring and management systems are known in the valet and parking industry that use computers, servers and, or handheld scanners for obtaining and processing customer, vehicle and valet attendant information and cameras to take still photographs or snapshots of vehicles to determine the condition of vehicles before and after rendering parking services. However, these systems do not improve vehicle delivery time to customers, enhance efficiency of valet operations, reduce costs or losses or improve efficiency as contemplated by the instant invention described herein. Conventional valet management systems and methods known require the presence of one or more employees or agents at the location where vehicles are received and processed to park and retrieve vehicles, manage and monitor employees, payroll, vehicles, valet attendants, revenue, costs, customer satisfaction and vehicle damage. Known valet operations are highly inefficient, are unreliable and do not provide a reasonable return on investment.

One of the main problems is that traditional valet systems lack real time communication with and between valet attendants parking and retrieving vehicles. Accordingly, a valet attendant parking a vehicle has no convenient or reliable way to know that a requested vehicle for retrieval is proximal the location of the vehicle being parked or otherwise conveniently accessible for retrieval compared to the other valet attendants parking and retrieving vehicles. For example, when parking and, or retrieving vehicles valet attendants in regular valet operations, similar to those employed at hotels, enter the garage and park the vehicle and then run back to the dispatch office for determining the next vehicle for pick up or to the receiving area to park another car, With current practices, they do not know whether there is a vehicle request for retrieval until they return to the dispatch office. Current valet systems and practices also fail to provide management and, or monitoring systems that reliably track, monitor and evaluate data on vehicles, customers, valet attendants, employees, employee theft, employee compensation, vehicle parking time, vehicle parking location and, or identification of the valet attendant in possession of a vehicle before, during and, or after parking a vehicle. This is because conventional parking control systems and methods currently employed use antiquated barcode systems, computer systems, software and still photography techniques to monitor vehicles, customers and valet attendants. The inability to reliably identify and monitor employees, employee performance, vehicles, valet attendants, customers and customer requests results in lost revenue and increased costs. Unfortunately, there are no known systems or methods that adequately address or resolve these problems.

Different companies offer different solutions for this, for example a competitor offers installing a printer that prints “vehicles requests” by the garage entry or computers all around the garage. These conventional solutions are hurting the valet operation more than helping the operation. They require extra costs and equipment and do not solve the problem. Valets still get confused on which valet is picking up which vehicle and must return to the dispatch area to clear up the confusion. If there existed a system that provided real time communication between valets and dispatch, it would alleviate this problem. No such system is known.

Various other vehicle valet storage and retrieval systems are known in the art. Conventional vehicle monitoring systems include the traditional paper-based, barcode and computer based systems, which require manual entry of vehicle information and do not effectively track employee, valet attendant or customer information. While there are vehicle valet management systems known that use barcodes or magnetic strips for identifying vehicle tickets and, or valet attendants, these devices or systems may be circumvented with current technology by switching, altering or counterfeiting such codes, devices or systems. In addition, regardless of technological advances, valet management and control systems known still require the manual entry of employee, vehicle or customer information, are not remotely operable and are vulnerable to circumvention. Moreover, conventional valet management devices, systems and methods known lack real time communication between valet attendants and with dispatch, are time-consuming, subject to human error and limited by conventional technology employed, such as disclosed in U.S. Pat. No. 4,720,785 issued to Shapiro, U.S. Pat. No. 4,990,757 issued to Edwards et al., and ‘U.S. Pat. No. 5,710,557 issued to Schuette.

Reliably identifying and tracking vehicle damage continues to be problematic. Attempts have been made to take still photographs, or snapshots, of vehicles with a fixed camera before and after parking a vehicle to determine if damage occurred while in custody of the valet company, such as disclosed in U.S. Pat. Nos. 6,630,893 and 7,342,511, issued to Schuette. These known systems also attempt to identify cognizant valet attendants with barcodes or magnetic strips, a well known practice in the valet industry. With respect to capturing vehicle damage, vehicle snapshots are taken from a set angle, which are not accurate or reliable for capturing existing damage, especially minor damage. The majority of parking-related damage comprises dents, dings and, or scratches, which are difficult, if not impossible, to see or photograph with any reliable certainty at one angle. This is in part because light conditions vary throughout the day and night, affecting the visibility of dents, dings and scratches and hence the ability to reliably capture damage using still photography. If there existed a system that allowed valet attendants to photograph or video vehicles to record a vehicle's pre-parking and post-parking condition it would improve reliability and reduce false claims.

Finally, conventional valet parking systems and methods also lack the ability to receive and process customer requests and feedback and, or management and monitoring data for valet operations from a remote location. For instance, before arriving at a location or leaving a location, a customer may want to make arrangements with a valet service to time delivery of their vehicle or to order services, such as washing the vehicle. Management may also desire to monitor and manage valet services, employees and, or customers from remote locations. Conventional devices, systems and methods known do not adequately address or resolve these issues. As cellular telecommunication technology has advanced to the point where cellular telephones and other devices, such as iPhone® and Blackberry®, communicate over the Internet®, it would be advantageous in the valet and parking industry to take advantage of this technology to improve customer service and management of the valet business. Unfortunately, there are no known systems or devices that adequately address or resolve these issues or goals.

If there existed an automated vehicle valet control system that improved valet service efficiency, enhanced customer satisfaction with faster delivery times and provided a more cost effective solution to the inadequacies of current valet operations it would be would be well received. Such a system would effectively, efficiently and automatically provide real time communication between valets and with dispatch to mitigate wasted effort and time when parking and retrieving vehicles, would improve customer satisfaction and improve the overall management of valet operations. This contemplated system would also harness modern technology to enhance valet operations, process vehicle and customer information, record pre-parking and post-parking conditions of vehicles, reliably identify valet attendants handling each vehicle and allow for monitoring employees and managing the valet business from a remote location. The instant invention addresses these unfulfilled needs in the prior art by providing an automated valet vehicle inventory and tracking system as contemplated by the instant invention disclosed herein.

### BRIEF SUMMARY OF THE INVENTION

In light of the foregoing, it is an object of the present invention to provide a wireless vehicle valet management system that reduces the time it takes to deliver a requested by approximately half compared to conventional systems and techniques

It is also an object of the present invention to provide a wireless vehicle valet management system that reduces the amount of man power and hours needed to provided valet parking and delivery services by approximately twenty percent (20%).

It is another object of the present invention to provide a wireless vehicle valet management system that reduces the costs for necessary hardware by approximately ten percent (10%).

It is an additional object of the present invention to provide a wireless vehicle valet management system that reduces the installation costs by approximately forty percent (40%).

It is a further object of the present invention to provide a wireless vehicle valet management system that employs wireless handheld communication devices and a system that allows a valet dispatch center to communicate with all valets in real time so as to more efficiently coordinate the pick-up and delivery of vehicles.

It is also an object of the present invention to provide a wireless vehicle valet management system that uses wireless handheld communication devices that allows a valet to verbally enter valet ticket numbers, the owner of a vehicle, the make, model and color of a vehicle and the license plate number of a vehicle into the handheld devices and system.

It is another object of the present invention to provide a wireless vehicle valet management system that uses wireless handheld communication devices that converts audio files of customer, vehicle and valet information into text files.

It is yet an additional object of the present invention to provide a wireless vehicle valet management system that uses wireless handheld communication devices that allows a valet to scan valet tickets and scan one or more bar codes, such as a vehicle identification number that identify the vehicle and the make, model and color of a vehicle and a bar code for the license plate number of a vehicle.

It is yet another object of the present invention to provide a wireless vehicle valet management system that employs wireless handheld communication devices that can take photographs and, or video of vehicles for use in determining pre-parking and post-parking conditions of vehicles.

It is yet a further object of the present invention to provide a wireless vehicle valet management system having an optical character decoding system (“OCD”) that decodes license plate information from a photograph of the license plate.

It is yet an additional object of the present invention to provide a wireless vehicle valet management system having a license plate recognition system (“LPR”) that decodes license plate information and corresponding owner and vehicle information.

It is still a further object of the present invention to provide a wireless vehicle valet management system that reduces the number of fraudulent claims that are successful.

It is also an object of the instant invention to provide a wireless vehicle valet management system that does not require the manual entry of vehicle or customer information on paper or in computers or handheld devices,

It is still another object of the present invention to provide a wireless vehicle valet management system that is adapted for using existing wireless communication devices, such as iPhones0 or comparable devices, for wirelessly communicating customer, vehicle and valet information to the system.

It is another object of the instant invention to provide a wireless vehicle valet management system that uses programmable barcodes and scanners to receive, identify and monitor vehicle information, such as owner, make, model, color, damage, time-in, time-out and costs.

It is also an object of the instant invention to provide a wireless vehicle valet management system that can use a single programmable barcode to identify and monitor vehicle information, such as owner, make, model, color, damage, time-in, time-out and costs.

It is still another object of the instant invention to provide a wireless vehicle valet management system that creates tickets with scrambled bar codes.

It is still an additional object of the instant invention to provide a wireless vehicle valet management system that uses a barcode tickets for identifying and tracking vehicles and valet attendants.

It is also an object of the instant invention to provide a wireless vehicle valet management system that can employ face recognition and, or fingerprint identification technology to record and monitor the valet attendant driving a vehicle.

It is yet an additional object of the instant invention to provide a wireless vehicle valet management system that is accessible over the Internet or through a wireless communication device for managing and monitoring the system.

It is yet a further object of the instant invention to provide a wireless vehicle valet management system that is accessible by customers through a wireless communication device, such as a cell phone, for arranging vehicle delivery or other vehicle services, such as washing or service,

It is still another object of the instant invention to provide a wireless vehicle valet management system having a validation process that can create master accounts and account receivables within the system.

It is yet another object of the instant invention to provide a wireless vehicle valet management system having a reliable and effective ticket inventory system that prevents fraud and theft.

In light of these and other objects, the instant invention is a wireless vehicle valet management system comprising multipart barcoded valet tickets, a plurality of wireless handheld communication devices for entering customer, vehicle and valet information and communicating it to the system, a server, software, at least one database and a communication network. The wireless handheld communication devices (also referenced herein as “handheld unit” or “units”) preferably comprise a cellular telephone having applications programming capability, such as iPhones® or comparable devices. Alternatively, the wireless handheld communication devices may comprise a Motorola® MC35 or comparable device.

The preferred wireless handheld communication device is able to receive audible inputs, i.e. speech, to enter customer, valet, valet attendant, vehicle and parking/delivery related information and wirelessly communicates this information to the server for access by dispatch and, or management. That is, the valet attendant is able to directly speak into the phone to identify the customer, license plate, vehicle information and other valet information, such as parking location. The audible file created and received by the system is converted to text and stored in the proper database for access and processing by valet operations.

The preferred wireless handheld communication device also offers the option of scanning this SELITIC or similar information into the handheld unit and transmitting it to the server for access by dispatch and, or management. For instance, the handheld unit may scan a valet or employee badge, YIN number or barcode ticket. By virtue of using these handheld units to communicate with the server, the system can send e mails to alert the dispatch desk, valet manager or guest services manager.

The handheld unit has multiple screen displays that display the customer ticket number, license plate number, parking location, customer name, vehicle make-model-color, wait times and other messages. The handheld units also have buttons for selecting the “scan” or “speak feature” and a “select & pickup” button for selecting a vehicle to be picked up and delivered to a requesting customer.

The system of the instant invention also comprises a map of the parking garage or area showing taken and available spots and related vehicle information. The vehicle arrival and departure times may also be stored and displayed. The handheld units also take, store and retrieve photographs of the vehicles handled by the valet company. The system of the instant invention also comprises a license plate recognition system (“LPR”) and, or optical character decoding system (“OCD”) for storing and decoding license plate and vehicle related information. The dimensions of the vehicle may also be determined and stored if needed.

One of the main features and advantages of the wireless communication handheld units adapted for the system of the instant invention is that the dispatch desk or management is able to communicate directly with the valet attendant while they are parking a vehicle so the valet attendant does not have to return to the dispatch area before receiving the next parking or vehicle delivery assignment. While a valet attendant is parking a vehicle they will receive an option of picking up another vehicle through their handheld unit. Every valet attendant will be able to access a list of available vehicles for pick-up or delivery. That is, on one screen, the handheld unit displays a list of vehicles ready for delivery to the dispatch area to the customer. After a valet attendant parks a vehicle they reference their handheld unit to select a vehicle for delivery. Once a valet selects a vehicle from the display list for driving to the customer at the dispatch area it is removed from the screens on all the valets' handheld units. This prevents another valet attendant from trying to get and deliver the same vehicle, which improves efficiency while eliminating confusion. This system also maintains a record of the valet attendants and the vehicles they are handling.

The instant invention can operate as follows. A customer or guest pulls into a garage or parking lot and stops at the dispatch area. The customer is given a ticket, preferably having a barcode on it. A valet attendant speaks or scans the barcoded, pre-printed valet ticket number into the wireless handheld communication device (handheld unit). The ticket number is converted to text, transmitted to the server and stored in the designated database location. The valet attendant then snaps a photograph of the license plate, which is decoded by the OCD and, or LPR systems of the instant invention within seconds and at wireless connection speed. VIP customers and repeat customers are identified as soon as the license plate number is entered into the handheld unit and system. New customers are automatically stored upon entering their license plate number. The system alerts the front/dispatch desk, valet manager and, or guest services manager by e mail of the customer in need of parking services. The system then sends a message to a valet attendant's handheld unit indicating the location where the vehicle is to be parked. This allows the valet attendant's resources to be utilized with maximum efficiency. The valet attendant then parks the vehicle in the designated spot in accordance with the message. If for any reason the vehicle is to be parked in another location or spot, the valet attendant scans or speaks the ticket number and new location into the system using its wireless handheld unit. This same process occurs if the vehicle needs to be moved to another spot in order to access another vehicle. That is, the valet attendant speaks or scans the ticket number and location into the handheld unit. The system of the instant invention continuously updates the parking garage map with new data.

When there is a vehicle request for delivery to a customer, all valet attendants receive an audible or visual alert message on their handheld units. Only one valet attendant will be able to select the vehicle for pickup and delivery because once a vehicle is selected it is removed from the “vehicle requests” screen on everyone's handheld units. To select a vehicle for pickup and delivery, the valet attendant highlights the vehicle on their handheld unit and actuates the “select & pickup” button on the unit. When a valet attendant picks up a vehicle, they speak or scan the ticket number on the ticket stub inside the vehicle, so the system knows that the vehicle has been located and in the process of being moved to the dispatch area. The ticket stub inside and corresponding to the parked vehicle has specific barcode information in the barcode that is different from the barcode information on the corresponding ticket stubs, i.e. dispatch stub and customer stub, to monitor the location and activity of the vehicle. Until the valet attendant delivers the selected vehicle to the customer at the dispatch area they are not able to select any other vehicle. The system knows that a vehicle has been delivered once it passes through the exit gate. The system is then updated.

The instant invention may also comprise a face recognition camera or fingerprint reader for recording the valet attendant driving a vehicle, face recognition and, or fingerprint decoding software, video cameras for recording vehicles as they enter a parking facility and access control unit software for controlling the valet camera, video camera and scanner components and correlating the valet photograph, vehicle and video to the corresponding barcoded ticket. The vehicle valet inventory and tracking system may also record video of vehicles when the exit a parking facility. The instant invention may further comprise a speed bump proximal to the access control unit and, or camera to cause a vehicle to stop, facilitating the taking of the valet driver's picture or fingerprint.

The parking system of the instant invention comprises a multipart barcode valet ticket. One section is for the customer and the other sections are for valet operations, wherein one stays with the vehicle and the other with the key. The valet driver chives the vehicle to the parking area and activates the camera to take a picture. Alternatively, the valet attendant places a designated finger against or in the fingerprint reader. Once the face or fingerprint recognition software confirms the valet attendant in control of the vehicle, the video cameras are activated and capture vide& of the vehicle while it is moving past the video cameras. The system software correlates the videos and valet picture to the valet ticket. If the garage has a control gate then the access control unit activates the gate upon validating the valet attendant, vehicle and ticket.

The instant invention correlates a valet photograph or fingerprint, vehicle video and scrambled barcode with a particular vehicle scanner. The instant invention also comprises a barcode based system and process that creates, processes, updates, accesses, monitors and retrieves data and, or data folders with vehicle, valet attendant and customer information. The vehicle inventory system of the instant invention may also comprise hardware and software for facilitating the use of other wireless communication devices, such as cellular telephones, Bluetooth® devices, Blackberry's® and other personal communication devices known to facilitate remote access, communication and, or control without having to rely on outdated computer servers or bulky PDA's. The barcode of the vehicle inventory system of the instant invention may also comprise or provide access to data related to employee performance, vehicle specifications, vehicle identification number (VIN), customer identification information and, or services ordered by the customer.

The instant invention may also create customer data folders from municipality or state issued vehicle registry decals and, or bar codes. The instant invention can decode state registry decals and collect data therefrom, such as license plate and VIN numbers. The instant invention further provides revenue control and tracking by providing an automatic electronic data entry system that prevents manipulation with parking times and car types that affect the amount of money charged and received. The instant invention also automatically determines the vehicle and time of entry and calculates the amount owed thereby rducing mistakes and manipulation.

The instant invention may also comprises a validation system that can create “master accounts/account receivables” within the system and create an scrambled barcoded numbers and letters, such as on stickers, and apply different parking rates to each account. Without using the sticker created with the system of the instant invention no one can fraudulently “validate” the tickets. The real charge is not known until after the sticker is scanned. The stickers of this system are barcoded with scrambled numbers and letters, With respect to the valet tickets, a customer claim ticket can include a letter in front of the numbers. This helps to eliminate very common cashier mistakes and also identifies to the system that the customer is currently present for payment. The system of the instant invention records whether the customer is the actual person or owner requesting the vehicle. If not, the system creates a missing ticket report.

The instant invention further comprises a ticket inventory system and method to insure the use of valid tickets rather than forged tickets. In the ticket inventory system and method of the instant invention, when the valet company receives the ordered tickets from their printing company they enter the ticket numbers into the ticket inventory system. The system is able to compare valid valet company tickets to fraudulent tickets. Thus, no other tickets may be used but the valid tickets entered into the ticket inventory system. The ticket inventory system of the instant invention also prevents the reuse of company tickets.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is an elevational representative view of the preferred wireless handheld communication device of the wireless vehicle valet management system in accordance with the preferred embodiment of the instant invention.

FIG. 2 is an elevational representative view of an alternative wireless handheld communication device of the wireless vehicle valet management system in accordance with the instant invention.

FIG. 3 is a screen display of vehicle parking location on the alternative wireless handheld communication device of the wireless vehicle valet management system in accordance with the instant invention.

FIG. 4 is a screen display of vehicle and customer information on the alternative wireless handheld communication device of the wireless vehicle valet management system in accordance with the instant invention.

FIG. 5 is a screen display of vehicle parking location on the alternative wireless handheld communication device of the wireless vehicle valet management system in accordance with the instant invention.

FIGS. 6A-C is a flow diagram of software of the preferred and alternative embodiments of the vehicle inventory system in accordance with the instant invention.

FIG. 7 is a system block diagram of the preferred and alternative embodiments of the vehicle inventory system in accordance with the instant invention.

FIG. 8 is a block diagram of the software modules of the preferred and alternative embodiments of the vehicle inventory system in accordance with the instant invention.

FIG. 9 is an elevational representative view of the multi-part barcode ticket of the vehicle inventory system in accordance with preferred embodiment of the instant invention.

FIG. 10 is a complete system and operations block diagram of the instant invention incorporating alternative features in accordance with the instant invention.

FIGS. 11-17 schematically depict a system for retrieval of a vehicle by valet attendants.

### DETAILED DESCRIPTION OF THE INVENTION

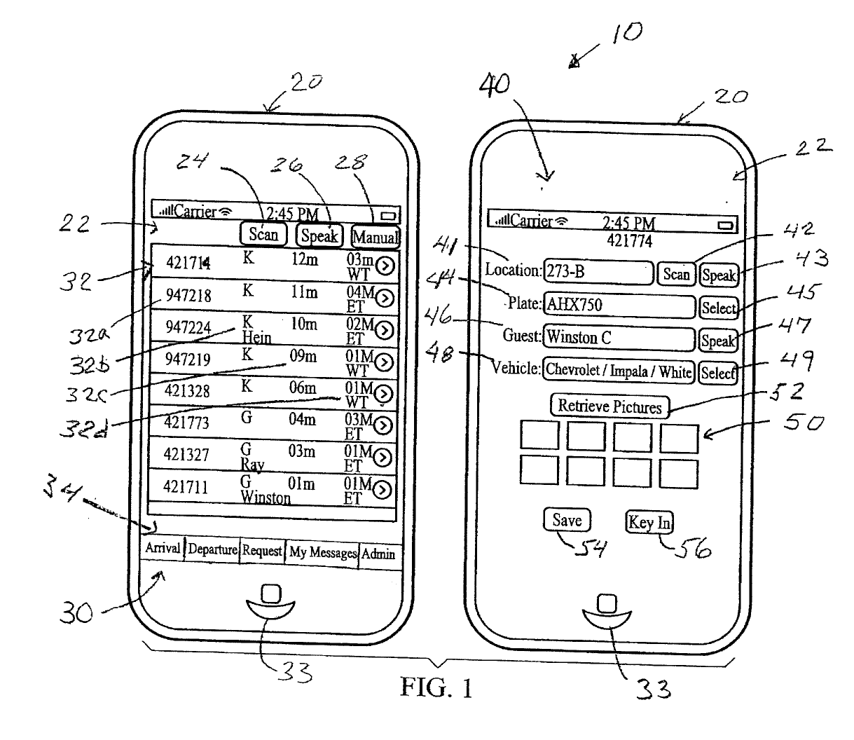

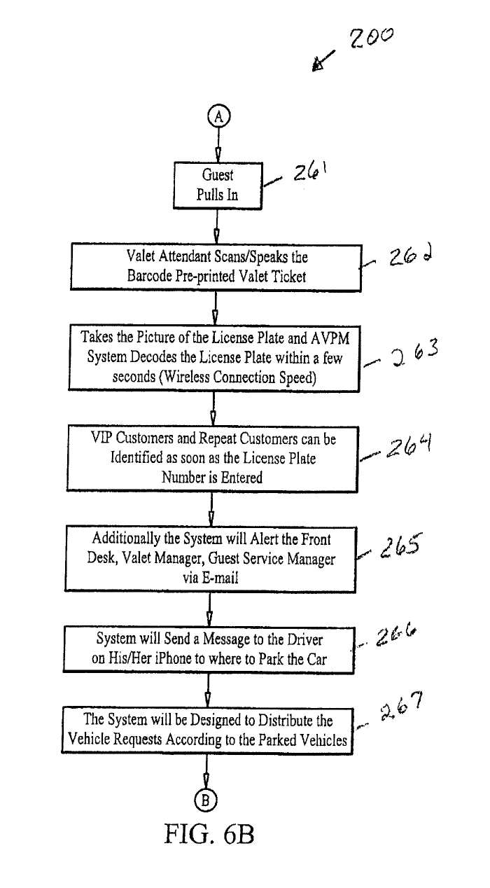

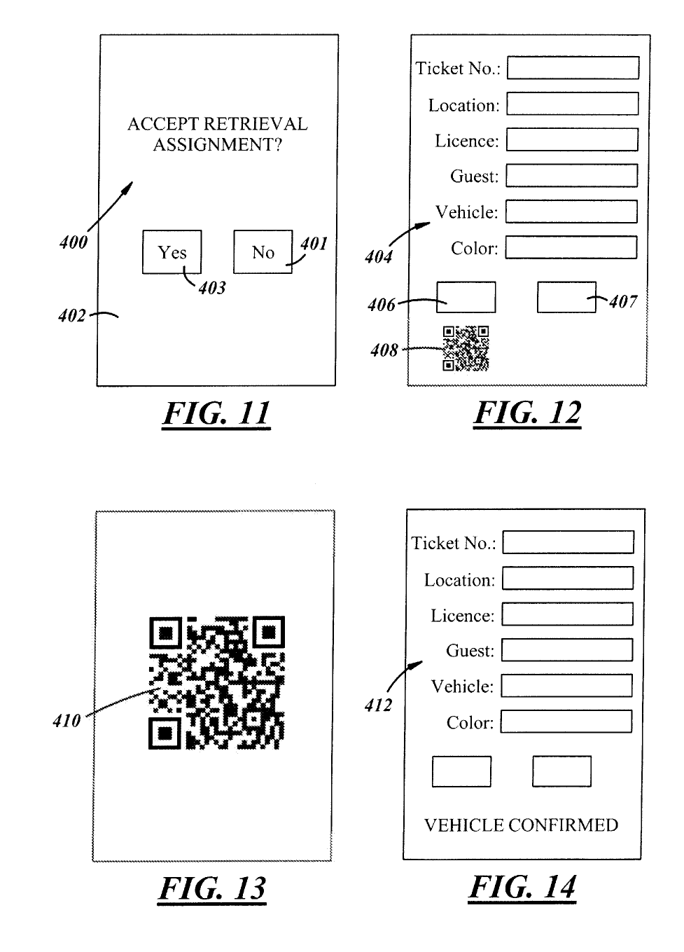

With reference to the drawings, FIGS. 1 to 10 depict the preferred and alternative embodiments of the instant invention which is generally referenced as a wireless vehicle valet management system and, or by numeric character 10. The wireless vehicle valet management system 10 comprises a wireless system that allows dispatch and management to communicate simultaneously with a plurality of valet attendants to streamline vehicle parking and pickup and management, while improving security, data management and customer service. The instant invention 10 enhances efficiency and customer service, reduces mistakes and improves the ability to monitor valet attendant and manage the valet operations and finances. The instant invention 10 eliminates the need for manually logging and entering vehicle and customer information into a system. Fraudulent vehicle damage claims are more easily monitored and prevented with the instant invention 10.

The instant invention 10 may also create customer data folders from VIN's and municipality or state issued vehicle registry decals and, or bar codes (genrally “decals”). The instant invention 10 can decode state registry decals and collect information from it, such as license plate numbers. The instant invention 10 further provides revenue control and tracking by providing an automatic electronic data entry system that prevents manipulation with parking times and car types that affect the amount of money charged and received. The instant invention 10 automatically determines the vehicle and time of entry and calculates the amount owed thereby reducing mistakes and manipulation.

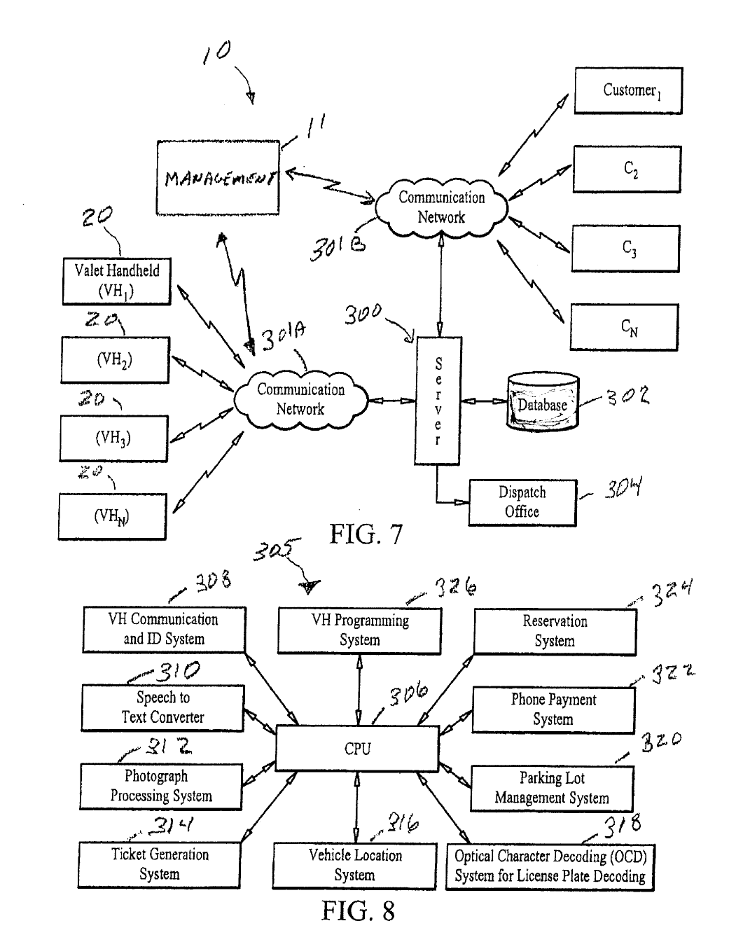

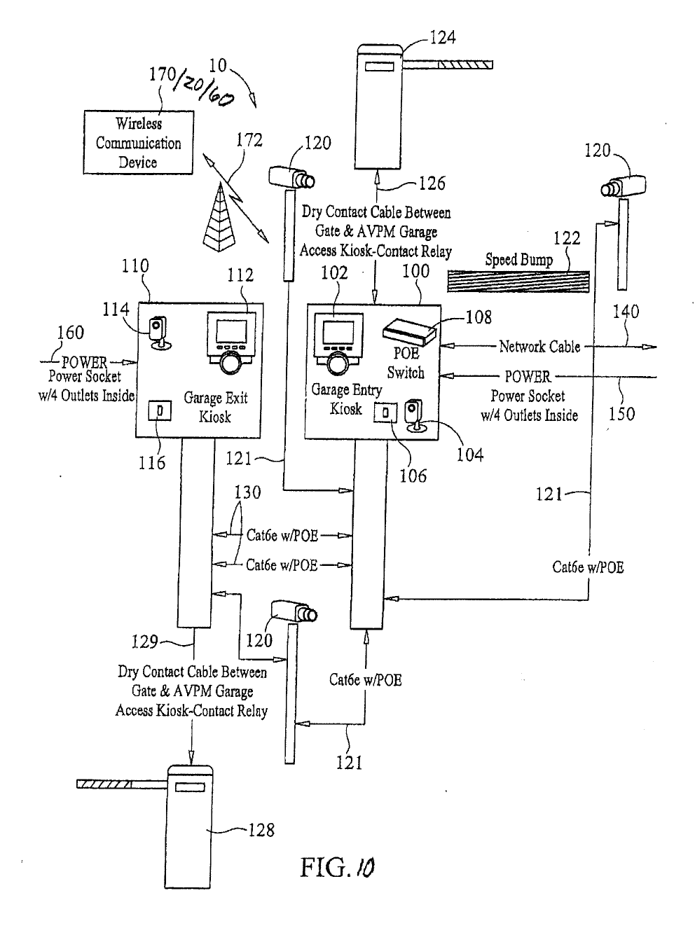

With reference to FIGS. 1-10, the instant invention is a wireless vehicle valet management system comprising multipart barcoded valet tickets 12, a plurality of wireless handheld communication devices 20 for entering customer, vehicle and valet information and communicating it to the system, a server 300, software 305, at least one database 302, a valet management communication network 301A and a customer communication network 301B. Management 11 can communicate with the system 10 through either communication network 301A or 301B, as shown in FIG. 7. With reference to FIG. 9, the ticket 12 comprises a customer stub 12 A and barcode 13A, vehicle stub 12B and barcode 13B that corresponds to the customer barcode 13b and dispatch center stub 12C and barcode 13C that corresponds to the customer barcode 13A and vehicle barcode 13B. The wireless handheld communication devices 12 (also referenced herein as “handheld unit or units”) preferably comprise a cellular telephone having applications programming capability, such as iPhones or comparable devices. The preferred handheld units 20 allow software applications 305 to be programmed and saved directly into the system 10 or handheld units 20 in accordance with user specifications.

The system 10 preferably stores and maintains control of the software 305 to prevent valet attendants from reprogramming their handheld units 20. One of the main features and advantages of the wireless communication handheld units 20 adapted for the system 10 of the instant invention is that the dispatch desk or management is able to communicate directly with the valet attendant while they are parking a vehicle so the valet attendant does not have to return to the dispatch area before receiving the next parking or vehicle delivery assignment. While a valet attendant is parking a vehicle they will receive an option of picking up another vehicle through their handheld unit 20. Every valet attendant will be able to access a list of available vehicles for pick-up or delivery. That is, on one screen, the handheld unit 20 on the first display 30 displays a list of vehicles ready for delivery to the dispatch area to the customer. After a valet attendant parks a vehicle they reference their handheld unit 20 select a vehicle for delivery by pressing the “>” key corresponding to the vehicle and ticket number. This activates the second display 40 to indicate where the vehicle is parked. Once a valet selects a vehicle from the display list 30 for driving to the customer at the dispatch area it is removed from the screens on all the valets' handheld units 20. This prevents another valet attendant from trying to get and deliver the same vehicle, which improves efficiency while eliminating confusion. This system also maintains a record of the valet attendants and the vehicles they are handling.

With reference to FIG. 1, the preferred wireless handheld communication devices 20 comprise an interactive screen 22 having a first interactive tactile display 30 and second interactive display 40. The first interactive display 30 comprises a “Scan” option 24, “Speak” option 26, “Manual” option 28 and customer information fields 32. The customer information fields 32 display the customer ticket number 32a, customer name 32b, current wait time 32c and anticipated delivery time and location 32c1. For instance, for ticket number “947224” (32a), Mr. Hein (32b) has been waiting 10 minutes (32c) and his vehicle is to be delivered in approximately 2 minutes to the East Tower (32d). To enter the customer information into the handheld unit 20 in the first display 30, the user can scan the information into the unit 20 by selecting the “Scan” option 24, verbally enter the information into the unit 20 by selecting the “Speak” option 26 or manually enter the information into the unit 20 by selecting the “Manual” option 28. The first display 30 also provides for displaying arrival time by selecting the “Arrival” option, departure time by selecting the “Departure” option, making a request by selecting the “Request” option, displaying messages by selecting the “My Messages” option or displaying administration information such as hours worked by selecting the “Admin” option.

Still referring to FIG. 1, the second display 40 shows the parking location 41, vehicle license plate number 44, customer name 46 and vehicle information (make/model/color) 48 for a particular ticket number. With reference to FIG. 1, pressing the “>” key for ticket number “421714,” the second display 40 shows Location 273-B (41), License Plate number “AHX750” (44), Guest/customer “Winston C” (46) and Vehicle “Chevrolet/Impala/White” (48). The second display 40 also has a “Scan” option 42 and “Speak” 43, 47 and “Select” 45, 49 options. The valet attendant may also take photographs of vehicles to record pre-parking and post parking condition of vehicles. The photographs are displayed in picture fields 50 on the second display 40 by actuating the “Retrieve Pictures” option. The second display 40 also has a “Key In” option 56 and “Save” option 54 for saving entered information.

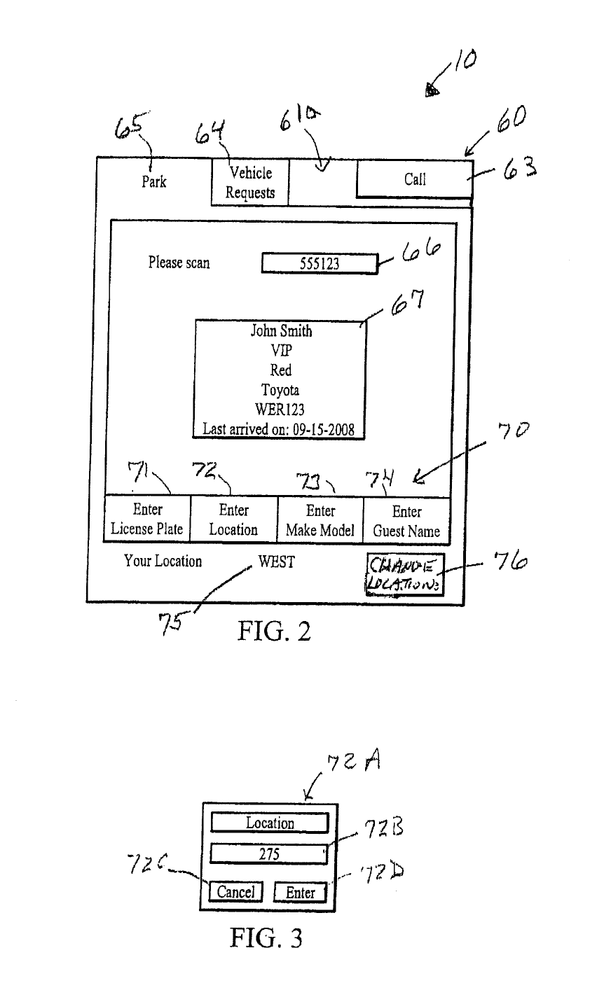

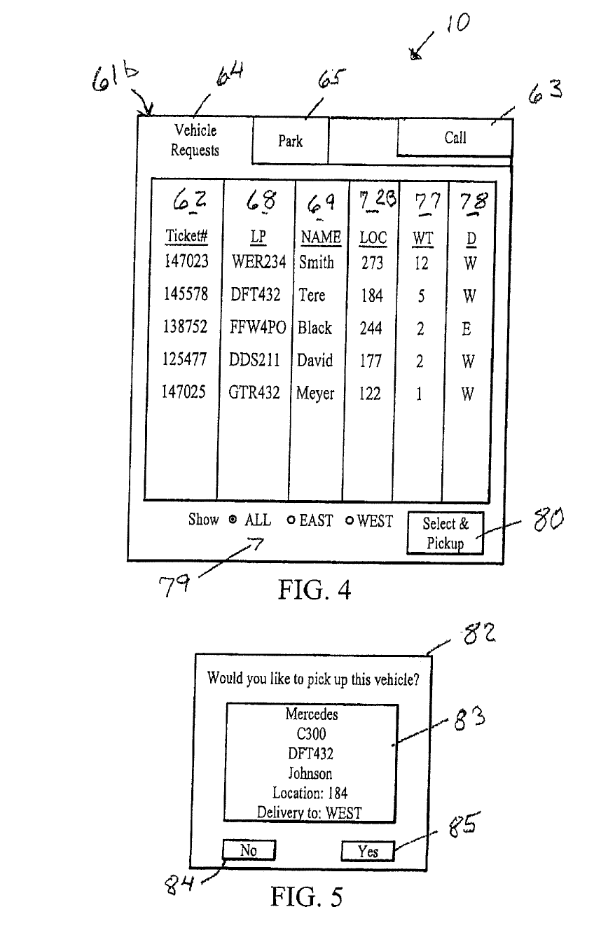

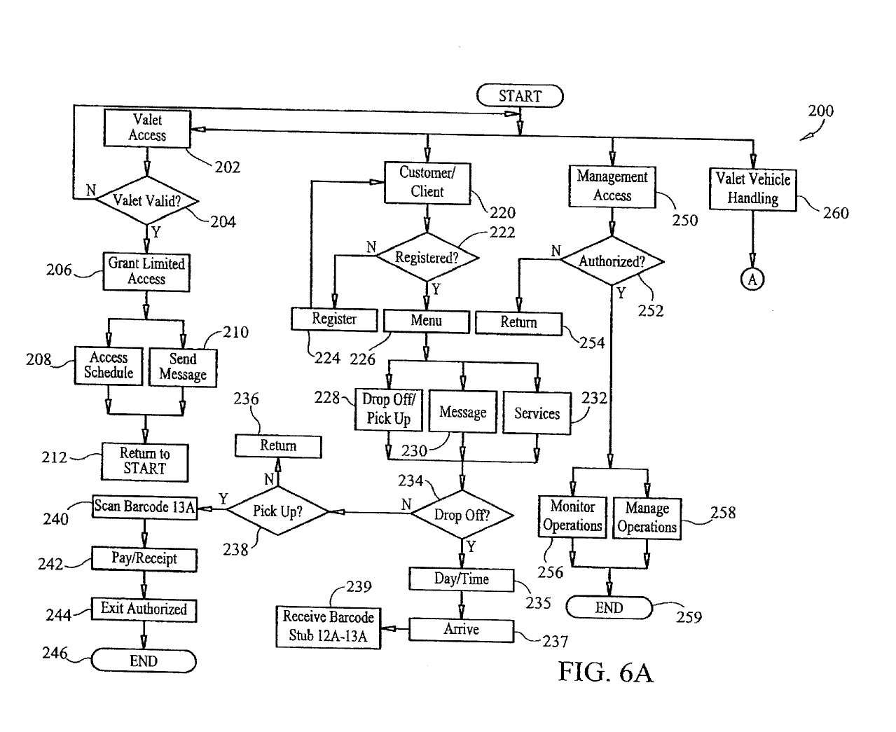

In an alternative embodiment, wireless handheld communication devices may comprise a Motorola° MC35 or comparable device 60 as shown in FIGS. 2-5. The alternative handheld units 60 preferably have all the features of the preferred handheld units 20, albeit with less convenient technology. With reference to FIGS. 2-5, the alternative units 60 has a first interactive display comprising a “Park” option 65 for parking a vehicle, “Vehicle Requests” option 64 for retrieving a parked vehicle, a “Call” option 63 for calling dispatch or other valet attendants, an “Enter License Plate” option 71 for entering a license plate number, “Enter Location” option 72 for entering the parking location, “Enter Make Model” option 73 for entering the make and model of the vehicles being parked, “Enter Guest Name” option 74 for entering the name of customers and “Change Location” option 76. The first display 61 a shows the general location 75 of a parked vehicle, the ticket number 66 and the customer name, status (VIP), vehicle make/model/color, license plate number and previous arrival date in a common field 67. The changed location 72B of a customer's vehicle is indicated and displayed in a separate field 72A by actuating the “Change Location” option 76, as shown in FIG. 3. With reference to FIG. 4, in another display 61b a list of all vehicles may be shown and include “Ticket #” 62, “LP” for license plate number 68, customer name 69, “LOC” for location 72B, ““WT” for wait time 77 and “D” for delivery location 78. This display 61b also allows the valet attendant to show “All” vehicles parked, vehicles parked in the “EAST” lot or vehicles parked in the “WEST” lot. When selecting a vehicle to pickup and delivery a particular vehicle from the list is selected and the “SELECT & PICKUP” option 80 pressed. When this is done a separate window 82 is actuated showing the vehicle and customer details in a separate field 83 and offering the options of picking up the vehicle by selecting the “YES” option or not picking up the vehicle by selecting the “NO” option 84.

With reference to FIGS. 1-5, as previously indicated herein, the wireless handheld communication device 20 is able to receive audible inputs, i.e. speech, to enter customer, valet, valet attendant, vehicle and parking/delivery related information and wirelessly communicates this information to the server for access by dispatch and, or management. Information is entered verbally by selecting a “Speak” option and talking into the speaker 33. That is, the valet attendant is able to directly speak into the phone speaker 33 to identify the customer, license plate, vehicle information and other valet information, such as parking location. The audible file created and received by the system 10 is converted to text and stored in the proper database for access and processing by valet operations, The preferred wireless handheld communication device 20 also offers the option of scanning this same or similar information into the handheld unit by selecting a “Scan” option and transmitting it to the server for access by dispatch and, or management. For instance, the handheld unit may scan a valet or employee badge, VIN number or barcode ticket. By virtue of using these handheld units 20 to communicate with the server, the system can send e mails to alert the dispatch desk, valet manager or guest services manager. The handheld unit has multiple screen displays that display the customer ticket number, license plate number, parking location, customer name, vehicle make-model-color, wait times and other messages, as shown in FIGS. 1-5. The handheld units also have hot buttons for selecting the “scan” or “speak feature” and a “select & pickup” button for selecting a vehicle to be picked up and delivered to a requesting customer.

The system of the instant invention also comprises a map of the parking garage or area showing taken and available spots and related vehicle information. The vehicle arrival and departure times may also be stored and displayed. The handheld units also take, store and retrieve photographs of the vehicles handled by the valet company. The system of the instant invention also comprises a license plate recognition system (“LPR”) and or optical character decoding system (“OCD”) for storing and decoding license plate and vehicle related information. The dimensions of the vehicle may also be determined and stored if needed.

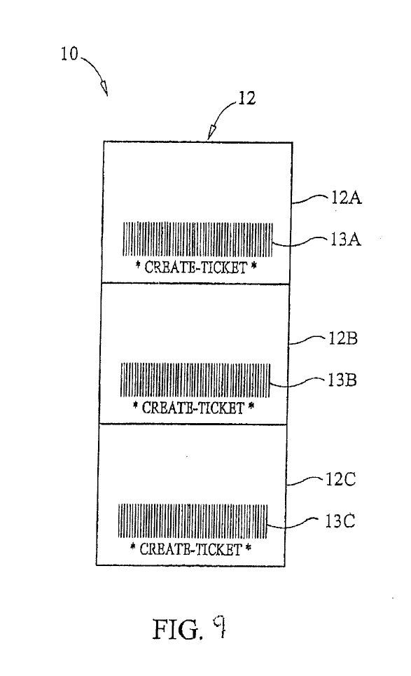

With reference to FIG. 8, the software 305 of the system 10 of the instant invention comprises a valet handheld communication and identification system module 308, speech to text converter module 310, photograph processing system module 312, ticket generation system module 314, vehicle location system module 316, OCD system module 318 for license plate decoding 318, parking lot management system module 320, phone payment system module 322 and reservation system module 324. The software 305 is operated by the server and all corresponding data is stored and retrieved from the database 302.

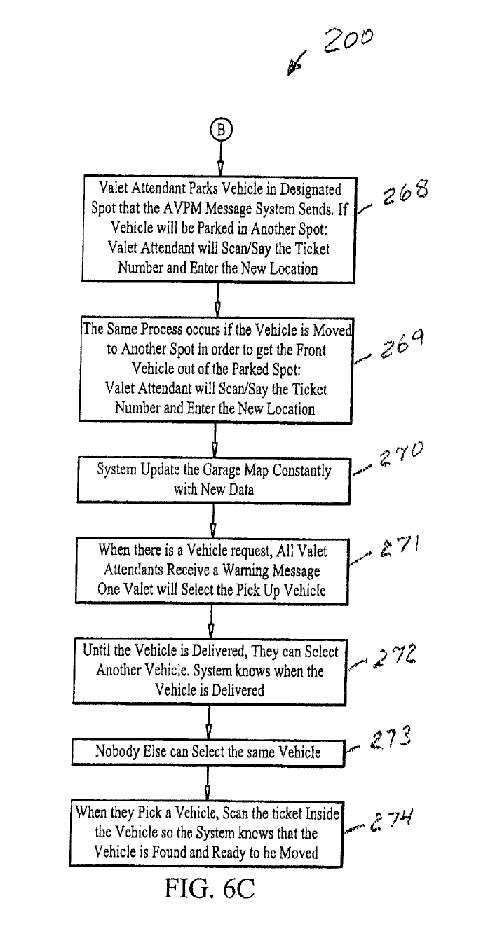

With reference to FIGS. 6A-6C, the software modules 308-326 operate in accordance with the overall software code 200 shown in steps 202-274. The operation of the instant invention 10 is dictated by the software code 200 which comprises the following process and code steps 202-276. With reference to FIG. 6A, the Valet Access process, customer process 220 and management access process 250 comprise steps 202- 259. With reference to FIG. 6C, the wireless vehicle valet management system 10 employing the wireless handheld communication devices 20 (or 60 in the alternative embodiment) of the instant invention 10 operates according to steps 261-274. Still referring to FIG. 6C, a customer or guest pulls into a garage or parking lot at stops at the dispatch area. The customer is given a ticket, preferably having a barcode on it. A valet attendant speaks or scans the barcoded, pre-printed valet ticket number into the wireless handheld communication device (handheld unit). The ticket number is converted to text, transmitted to the server and stored in the designated database location. The valet attendant then snaps a photograph of the license plate, which is decoded by the OCD and, or LPR systems of the instant invention within seconds and at wireless connection speed, VIP customers and repeat customers are identified as soon as the license plate number is entered into the handheld unit and system. New customers are automatically stored upon entering their license plate number.

The system alerts the front/dispatch desk, valet manager and, or guest services manager by email of the customer in need of parking services. The system then sends a message to a valet attendant's handheld unit indicating the location where the vehicle is to be parked. This allows the valet attendant's resources to be utilized with maximum efficiency. The valet attendant then parks the vehicle in the designated spot in accordance with the message.

If for any reason the vehicle is to be parked in another location or spot, the valet attendant scans or speaks the ticket number and new location into the system using its wireless handheld unit. This same process occurs if the vehicle needs to be moved to another spot in order to access another vehicle. That is, the valet attendant speaks or scans the ticket number and location into the handheld unit. The system of the instant invention continuously updates the parking garage map with new data.

When there is a vehicle request for delivery to a customer, all valet attendants receive an audible or visual alert message on their handheld units. Only one valet attendant will be able to select the vehicle for pickup and delivery because once a vehicle is selected it is removed from the “vehicle requests” screen on everyone's handheld units. To select a vehicle for pickup and delivery, the valet attendant highlights the vehicle on their handheld unit and actuates the “select & pickup” button on the unit, When a valet attendant picks up a vehicle, they speak or scan the ticket number on the ticket stub inside the vehicle, so the system knows that the vehicle has been located and in the process of being moved to the dispatch area. The ticket stub inside and corresponding to the parked vehicle has specific barcode information in the barcode that is different from the barcode information on the corresponding ticket stills, i.e., dispatch stub and customer stub, to monitor the location and activity of the vehicle. Until the valet attendant delivers the selected vehicle to the customer at the dispatch area they are not able to select any other vehicle. The system knows that a vehicle has been delivered once it passes through the exit gate. The system is then updated.

The instant invention 10 generates a customer ticket with bar code 13. The scanner 11 reads and processes the customer ticket bar code 13 for customer identification information and generates a customer and vehicle folder with data read and obtained from a pre-existing VIN barcode 64 for the vehicle make, model and year. Customer folders are generated with vehicle color, vehicle tag information and damage by scanning the corresponding color bar code(s) 28 from the color ticket 26, alphabet (a-z) and numeric (0-9) bar codes 20 and 24 respectively, and damage bar codes 42-56 for location and types of damage. The alphabet bar codes 20 preferably comprise bar codes for every letter and the numeric bar codes 24 preferably comprise bar codes for every number between 0-9. The instant invention 10 comprises vehicle color bar code 28 for vehicle color, the state tag bar code 16 for the state of vehicle registration, the alphabet bar codes 20 for letters in the vehicle tag, the numeric bar codes 24 for numbers in the vehicle tag, front-driver side-passenger side-back side damage location bar codes 42-48, dent-broken-scratched bar codes 50-54, VIP bar codes 56 and duration bar codes 62. The instant invention 10 may comprise bar codes for other colors and identifying information. The customer bar code 13 identifies the customer and customer related information from the bar codes 13-62.

The scanner 11 stores and transfers the data obtained from the bar codes 13-62 as scanned. The attendant bar code identifies who received and served the vehicle wherein the scanner 11 is assigned to the attendant at the start of the workday. The attendant parking and, or retrieving the vehicle is determined by scanning the attendant bar code. Damage control is achieved with the damage bar codes 42-54. The date bar codes 62 provide check-in and check-out information. The VIP bar code 56 identifies preferred customers. Data is obtained by aiming the scanner 11 at the bar codes. The scanner 11 stores the data and can transfer it as well.

Another feature of the invention is to locate, attach or position a scanable or electronically readable indicia, such as a bar code, at each parking locatior in the parking garage or lot (“parking facility”). The barcode could be attached to a wall, pillar or the like. In this manner, when the attendant parks the vehicle in an empty space, the barcode at that location can be scanned and relayed back to the control office. This information is placed in the computer memory and file relative to the parked vehicle for retrieval and other purposes.

The barcode can be any of the conventional types, such as one dimensional or two dimensional barcodes. The two dimensional type is also called “QR code” or a matrix code, and consists of black modules (square dots) arranged in a square pattern on a white background. The information encoded, for example, can be made up of four standard types (“modes”) of data (numeric, alphanumeric, byte/binary and Kanji).

Once the attendant parks the customer's vehicle and scans in the parking location, this notifies the central (or dispatch) office that the attendant is free to retrieve another vehicle and return it to a customer. If a car has been requested to be retrieved, the inventive system sends a signal (i.e. notifies in some manner) the attendant whose last known location was the closest to the parking space for the car to be retrieved. The notification can be graphical, like an email or text, on the attendant's handheld device, or it can be an audio signal or message, or both. For example, the system could include a particular audio tone of some type in order to notify the attendant that a vehicle needs to be retrieved and to look at his handheld device for the parking location, type of vehicle, etc. If the parking system includes steps in the parking and retrieval system which includes taking digital snapshots or a video of the vehicles, then it is also preferable that a picture of the vehicle to be retrieved is sent to and displayed on the attendant's handheld device. In this manner, the attendant immediately becomes aware of the make, type and color of the vehicle. This will assist the attendant in more quickly finding and identifying the vehicle to be retrieved.

The inventive system increases the speed and efficiency of the retrieval of parked vehicles for customers. The valet attendants in the parking lot or structure who are closest to the vehicle to be retrieved are notified and requested to retrieve the vehicle. Since attendants who are parking vehicles are instructed to notify the central office when the car is parked, as well as the location, such as, for example, by scanning into the system the electronically readable indicia on the parking space, the system is aware of the location of an attendant who is nearby and free to retrieve a vehicle.

Preferably, the attendant closest to the vehicle to be retrieved is first notified and requested to retrieve the vehicle. If that attendant responds and indicates that he or she will do so, that retrieval request is indicated as being satisfied. If the attendant closest to the vehicle to be retrieved cannot or does not want to retrieve the vehicle (for whatever reason), and declines the request, then the attendant whose last known location is second closest to the vehicle to be retrieved is notified and asked to retrieve it. This procedure continues until an attendant is found in the parking facility who agrees to secure the vehicle to be retrieved. Of course, if none of the attendants are currently still located in the parking facility, the retrieval request will be given to the attendant at the base location (i.e. dispatch desk) who is next in line to retrieve a vehicle.

As an alternative retrieval system, the handheld devices being used by the attendants have a unique positioning sensor or a global positioning system (“GPS”), which indicates the position or location of the attendants at all times in the parking facility. These locations could all be indicated on a master map or monitor screen which would allow the dispatcher to be able to contact the attendant (electronically or manually) who is physically closest to the parking location of a vehicle to be retrieved. In one embodiment, such notification is performed electronically (automatically) by a software system designed to designate the attendants who are physically closest to the vehicle to be retrieved. The attendant or attendants then who are closest to the vehicle are notified in the same manner as discussed above (by email, text, audio signal, etc.) and requested to retrieve the vehicle.

In another embodiment, the map of the parking garage or area is displayed on a monitor at a central location, preferably at the manager's or dispatch office. In that manner, all of the empty locations (a/k/a “parking stalls”) could be indicated and displayed, such as by a different color, icons, blinking indicia, or the like. This information also can be used as a component of the procedure used to select a parking location for a new vehicle to be parked.

In order to save time relative to the parking and retrieval of vehicles, another embodiment parks newly arrived vehicles in open parking spaces that are the closest or shortest distance to the area where the valet attendants are located, or where vehicles are dropped off or retrieved. Thus, when a new vehicle arrives at the parking facility, the computer indicates the closest open space and instructs the attendant accordingly. That information also is stored in the computer memory relative to the vehicle, and also can be indicated on the ticket if desired.

In still another embodiment, a plurality of video cameras are positioned throughout the parking facility. Each parking spot is then visually accessible on monitors at the dispatch office. With this system, the attendants who are the closest to the parking spot and to the vehicle to be retrieved are readily visible to the dispatcher or central office. This system could also double as a security system and preferably be similar to multi-camera, multi-monitor security systems in use today at numerous buildings and companies. If the video monitors visually show all of the parking locations in the facility, and the parking locations of the vehicle to be retrieved is known, then the dispatcher would be able to determine which attendant shown on a monitor were the closest to the vehicle. One or more of the attendants would then be notified in the manner discussed above, either electronically or by audio signal, and requested to retrieve the vehicle.

Once an attendant indicates that he or she will retrieve the vehicle at issue and return it to the customer at the retrieval location, the procedure shifts to the next vehicle to be retrieved.

As indicated in accordance with an embodiment of the invention, vehicle requests (for retrieval) will be distributed to valet attendants based on their physical location and availability status. Depending on the status of the valet attendant, which could be parking a vehicle, retrieving a vehicle, waiting by the dispatch desk, etc., the system will note the attendant's locations and place his or her availability for vehicle parking and vehicle retrieving accordingly.

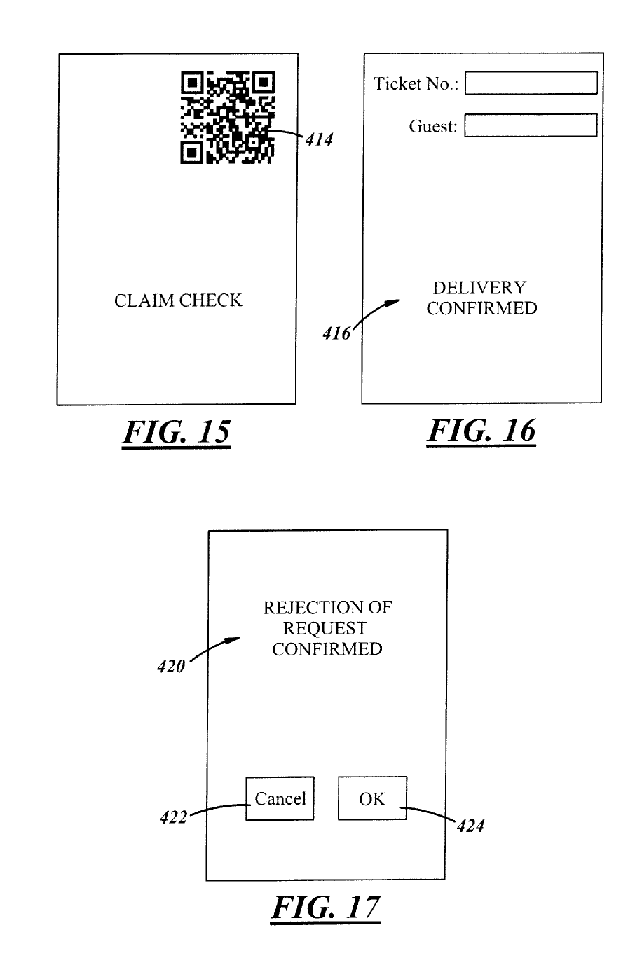

A representative system which accomplishes this is shown in FIG. 11-17. When the valet attendant is available, especially because his present or last known location is close to, or the closest of all of the attendants to, the location of the vehicle to be retrieved, the attendant will receive an electronic message 400 on his/her handheld device 402 as shown in FIG. 11. An audio signal can accompany the message to insure the attendant will read it.

If the attendant accepts the assignment, the “Yes” button 403 is pressed. If the attendant declines the assignment, the “No” button 401 is pressed.

If the assignment is accepted, the system electronically sends details of the ticket information in a second screen 404, as shown in FIG. 12. The information includes the Ticket Number, Vehicle Location, License Number, Customer Name (“Guest”). Vehicle Type and/or Model, and Color. If photographs of the vehicle have been taken and stored in the customer's file, then one or more pictures 406, 407 can also be displayed. Th barcode 408 of the Customer's Ticket is also displayed.

Once the valet attendant reaches the vehicle, the attendant scans the bar code 410 on the ticket portion attached to the keys of the vehicle with the handheld device. This is shown in FIG. 13. The system compares the scanned barcode with the barcode for the customer and vehicle in the computer database and confirms 412 that the correct vehicle is being retrieved. This is shown in FIG. 14.

When the vehicle is returned to the customer at the dispatch desk or vehicle retrieval area, the customer's claim check is scanned 414 to confirm delivery. This is the stub portion of the ticket that the customer was given when the vehicle was parked. This is shown in FIG. 15. This is after the customer has paid the cashier for the parking.

Thereafter, a message 416 is sent to the valet attendant indicating that the retrieval process has been completed. This is shown in FIG. 16.

If the valet attendant denies the request to retrieve a vehicle, the “No” button 401 in FIG. 11 is pressed. The system then sends a message 420 to the attendant confirming the denial, as shown in FIG. 17. A “Cancel” button 422 is also provided at this point in case the attendant changes his/her mind and decides to accept the assignment. If so, electronic message 400 is resent and the steps shown in FIGS. 12-16 takes place.

If the vehicle attendant continues to deny the request, the “OK” button 424 is pressed. The retrieval request is then immediately sent to the valet attendant who is the next closest to the parking location to the vehicle to be retrieved. This is discussed above.

The names of the attendants who have denied a retrieval request can be placed in an “unavoidable status” for a certain length of time, such as 5 or 10 minutes. After that period of time has passed, the system automatically places the attendant back on “availability status”. The attendant can also scan a location barcode while under the unavailable status to go back to available status at any time.

The history of “denials” by the attendants can also be kept in the computer records and taken into account periodically, particularly at his/her review.

As indicated, once the customer has paid the cashier for the parking, a vehicle request is made to the first available valet attendant. This is preferably the attendant where his/her last known location is the closest to the parking location of the vehicle to be retrieved. If the request is denied, it is offered to the next available attendant and so on. If the vehicle request has been on the queue for more than a predetermined period of time, such as 5 minutes, and not agreed to be picked up by an attendant in the facility, then the ticket is provided electronically to any attendant, such as those at the dispatch desk, who wants to pick up the vehicle for delivery. From that point, the valet attendant can manually select the assignment from the request screen and complete the delivery.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A method of valet parking of vehicles at a parking facility, comprising:
(a) providing a ticket to a customer for a first vehicle presented by a first customer for parking, said ticket having electronically readable indicia thereon;
(b) storing the electronically readable indicia together with vehicle identification information into a computer memory;
(c) parking the first vehicle by a first valet attendant at a first parking location in the parking facility, said first parking location having a unique electronically readable indicia identifying said first location;
(d) entering said unique electronically readable indicia identifying said first parking location into a computer memory; and
(e) electronically notifying said first parking attendant of a second vehicle in the parking facility at a second parking location which needs to be retrieved while said first parking attendant is at said first parking location or soon thereafter.

2. The method as described in claim 1 wherein step (d) of entering said unique electronically readable indicia identifying said first parking location is performed using a handheld mobile transreceiver.

3. The method as described in claim 1 wherein said unique electronically readable indicia identifying said first parking location is a barcode.

4. The method as described in claim 1 further comprising the steps of providing an electronic notification by said first parking attendant that said first parking attendant will retrieve said vehicle; and retrieving said vehicle.

5. The method as described in claim 1 further comprising the steps of:
providing an electronic notification by said first parking attendant that said first parking attendant will not retrieve said second vehicle; and
electronically notifying a second parking attendant that said second vehicle needs to be retrieved.

6. The method as described in claim 1 further comprising the step of taking pictures of the first vehicle prior to parking said first vehicle in a first parking location.

7. The method as described in claim 1 further comprising the step of taking pictures of the first vehicle and entering said pictures into a computer memory.

8. The method as described in claim 7 wherein the step (e) further comprises sending at least one picture of said first vehicle to the first parking attendant.

9. A method of retrieving parked vehicles in a parking facility having a plurality of parking attendants for parking and retrieving vehicles for customers, said method comprising the steps of:
providing unique electronically readable indicia at each vehicle parking location in the parking facility;
providing each valet attendant with an electronic wireless handheld mobile device, said device being able to read and scan said unique electronically readable indicia at said vehicle parking locations;
electronically tracking the physical location of each of said valet attendants in the parking facility based on the location of each of said electronic wireless handheld mobile devices;
electronically notifying at least one of said valet attendants of the parking location of a customer's vehicle to be retrieved;
said at least one of said valet attendant being the valet attendant closest in physical direction to the parking location of the vehicle to be retrieved; and
retrieving the vehicle from said parking location and retrieving it to a customer.

10. The method as described in claim 9 wherein a plurality of parking attendants are provided to valet park and retrieve vehicles in the parking facility, and further comprising the step of electronically tracking the locations of each of said parking attendants while each are in the parking facility.

11. The method as described in claim 10 further comprising the step of electronically notifying at least one parking attendant who is physically at a location near a parking location which has a vehicle which needs to be retrieved and returned to a customer.

12. The method as described in claim 11 further comprising the step of electronically requesting at least one of said near parking attendants to retrieve a vehicle.

13. The method as described in claim 9 further comprising the step of taking pictures of the first vehicle prior to parking said first vehicle in a first parking location.

14. The method as described in claim 9 further comprising the step of taking pictures of the first vehicle and entering said pictures into a computer memory.

15. The method as described in claim 14 wherein the step (e) further comprises sending at least one picture of said first vehicle to the first parking attendant.
